(19) United States
(12) Patent Application Publication
(10) Pub. No.: US 2009/0033083 A1
(43) Pub. Date: Feb. 5, 2009

(54) Interior Structure For Vehicle Near Instrument Panel And Column Cover

(75) Inventors: Takayuki KOBAYASHI, Fuji-shi (JP); Hirofumi NAKATSUKASA, Fuji-shi (JP)

Correspondence Address: NDQ&M WATCHSTONE LLP, 1300 EYE STREET, NW, SUITE 1000 WEST TOWER, WASHINGTON, DC, 20005, US

(73) Assignee: NIHON PLAST CO., LTD., Fuji-shi (JP)

(21) Appl. No.: 12/182,491

(22) Filed: Jul. 30, 2008

(30) Foreign Application Priority Data
Jul. 31, 2007 (JP) JP2007-199821

(51) Int. Cl. B62D 1/16

(52) U.S. Cl. 280/779

(57) ABSTRACT

An interior structure for a vehicle includes a cover. The cover includes a pair of attachments and arranged above a column cover. One of the attachments is attached to an instrument panel and another of the attachments is attached to a column cover. Then, the cover screens a gap between the instrument panel and the column cover. The cover includes a flexible main element and a pair of retainers. The main element further includes a pair of attached areas and an intermediate area joining the attached areas. The retainers are fixed to the attached areas to compose the attachments, respectively. According to the interior structure, attaching workability of the cover and an appearance are improved.

### CROSS REFERENCE TO RELATED APPLICATION

The present application claims benefit of priority from Japanese Patent Application No. 2007-199821 filed in Japan on Jul. 31, 2007, which is hereby incorporated by reference.

### BACKGROUND OF THE INVENTION

1. Field of the Invention

The present invention relates to an interior structure for a vehicle.

2. Description of the Related Art

Heretofore, in a vehicle, a steering column supporting a steering wheel is covered by a column cover and a steering wheel position can be adjusted up and down. In such a vehicle, a gap between the column cover and an instrument panel may become relatively large depending on the steering wheel position.

A proposal for solving the above issue is disclosed in Japanese Laid-Open Application Publication No. 2005-7965 (Patent Document 1). In the proposal, a cover is attached between the column cover and the instrument panel in order to screen the gap. Since the gap between the column cover and the instrument panel is screened by the cover, an appearance of a vehicle interior can be improved.

### SUMMARY OF THE INVENTION

However, since the cover (blind member) disclosed in the above Patent Document 1 is a rubber-molded single component, its attached portions onto the column cover and the instrument panel does not have good shape-retainment. As a result, the attached portions tend to deform, so that attaching workability of the cover and its appearance become retarded.

Therefore, an object of the present invention is to provide an interior structure for a vehicle that can improve attaching workability and appearance of a cover for hiding a gap between a column cover and an instrument panel.

An aspect of the present invention provides an interior structure for a vehicle that includes an instrument panel, a column cover fixed to a steering column at a position surrounding the steering column, and a cover which includes a pair of attachments and is positioned above the column cover for screening a gap between the instrument panel and the column cover. One of the attachments is attached to the instrument panel and another of the attachments is attached to the column cover. The cover further includes a flexible main element and a pair of retainers. The main element includes a pair of attached areas composing the attachments and an intermediate area joining the attached areas. The retainers are attached to the attached areas, respectively, and compose the attachments, respectively.

It is preferable that the attached areas are fixed to the retainers by sewing, respectively.

It is further preferable that at least one of the retainers includes a thin area and a thick area, and the attached area associated with the at least of the retainers is fixed to the thin area by sewing.

It is yet further preferable that the thin area and the thick area extend in longitudinally parallel along the at least one of the retainers.

It is preferable that the one of the attachments has a conforming shape to the instrument panel, and the other of the attachments has a conforming shape to the column cover.

It is preferable that a lateral width of the one of the attachments is made wider than a lateral width of the other attachments.

According to the interior structure of the present invention, since shape-retainments of the attachments can be improved due to strengthening stiffness of the attachments reinforced by the retainers, attaching workability and an appearance of the cover 6 can be improved.

### BRIEF DESCRIPTION OF THE DRAWINGS

FIG. 1 is a cross-sectional side view showing an embodiment of an interior structure for a vehicle according to the present invention;

FIG. 2 is a rear view of the embodiment of the interior structure according to the present invention;

FIG. 3 is a perspective view showing a cover in the embodiment of the interior structure according to the present invention;

FIG. 4 is a take-apart perspective view showing the cover in the embodiment of the interior structure according to the present invention;

FIG. 5 is an enlarged perspective view (partially cross-sectional view) showing an upper attachment of the cover in the embodiment of the interior structure according to the present invention; and

FIG. 6 is an enlarged perspective view (partially cross-sectional view) showing a lower attachment of the cover in the embodiment of the interior structure according to the present invention.

### DETAILED DESCRIPTION OF THE EMBODIMENT

An embodiment according to the present invention will be described with reference to drawings.

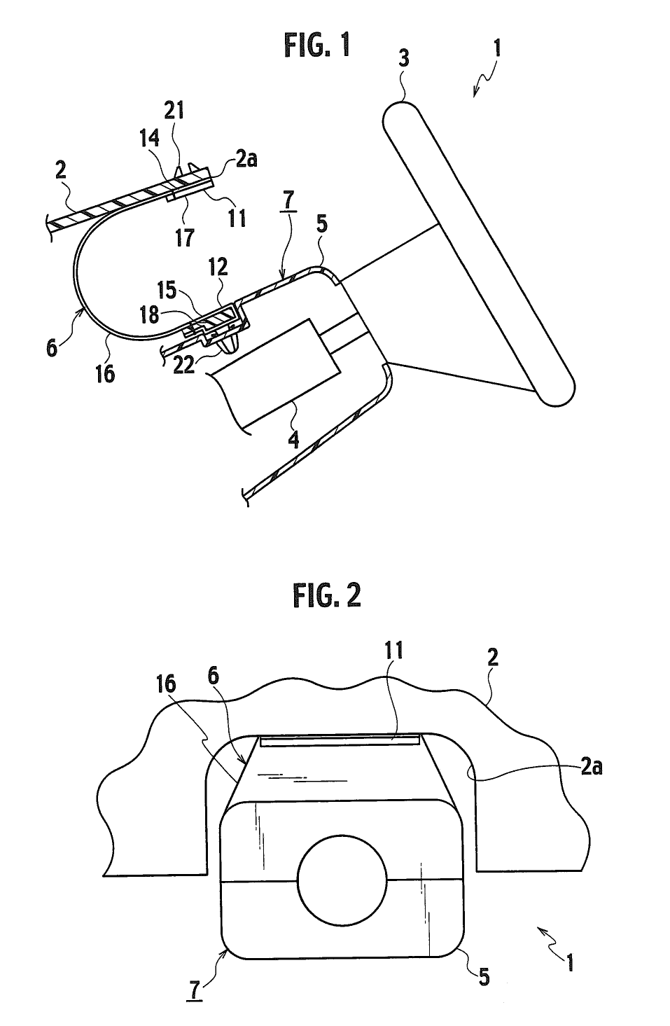

As shown in FIGS. 1 and 2, in an anterior area within a vehicle compartment 1, equipped are an instrument panel 2, a steering wheel 3 provided behind the instrument panel 2, a steering column 4 supporting the steering wheel 3, a column cover 5 surrounding the steering column 4, and a cover 6 bridged between the instrument panel 2 and the column cover 5. An interior structure 7 of a vehicle is configured with the instrument panel 2, the column cover 5 and the cover 6. Note that the steering wheel 3 and the steering column 4 are not shown in FIG. 2.

An opening 2a hollowed upward is formed on a lower end of the instrument panel 2. The steering column 4 and the column cover 5 are arranged within the opening 2a.

The steering column 4 is attached onto a frame structure (not shown) of a vehicle body in a tilted state diagonally front down. The steering wheel 3 is attached on the rear end of the steering column 4. The steering column 4 supports the steering wheel 3 rotatably, tilt-adjustably and telescopically.

The column cover 5 is molded of resin and has a cylindrical shape. The column cover 5 has a structure capable of being divided into an upper part and a lower part. The column cover 5 is attached to the steering column 4 at a position entirely surrounding the rear end of the steering column 4.

The cover 6 has a U-shaped side view so as to open diagonally rear-upward. The cover 6 is positioned above the column cover 5 and positioned between the column cover 5 and the instrument panel 2. Then the cover 6 screens a gap between the column cover 5 and the instrument panel 2. The cover 6 includes a pair of attachments on its upper and lower ends, which are an upper attachment 11 and a lower attachment 12.

The upper attachment 11 is attached to the instrument panel 2 and the lower attachment 12 is attached to the column cover 5. The upper attachment 11 is formed so as to conform to the shape of the instrument panel 2 and the lower attachment 12 is formed so as to conform to the shape of the column cover 5. In addition, the width of the lower attachment 12 is made wider than that of the upper attachment 11, so that the attached cover 6 have an almost trapezoidal shape with being seen along an axis of the steering column 4.

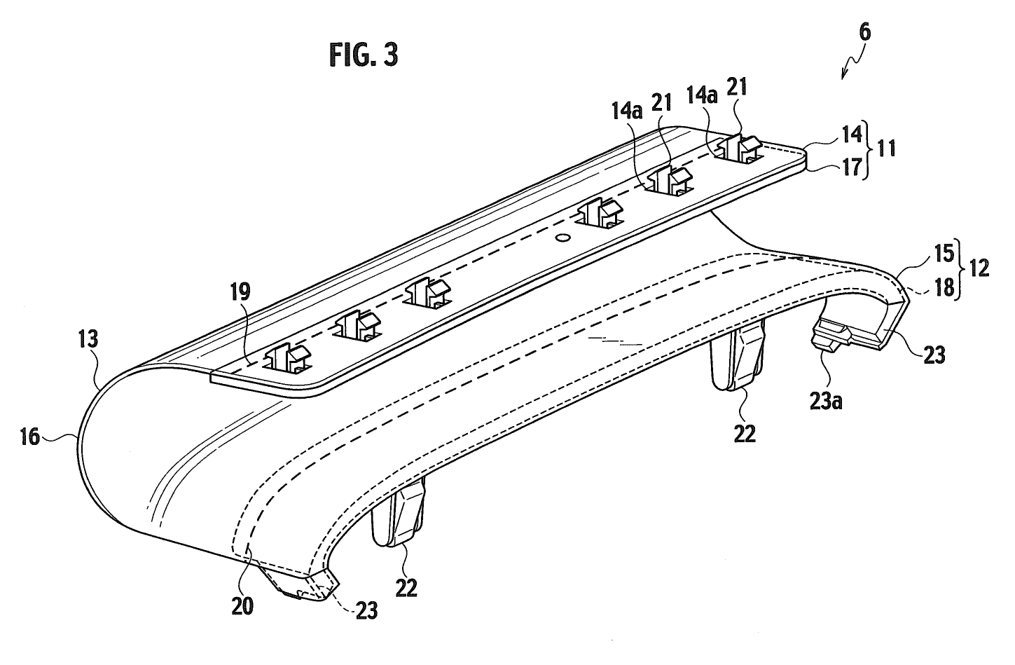

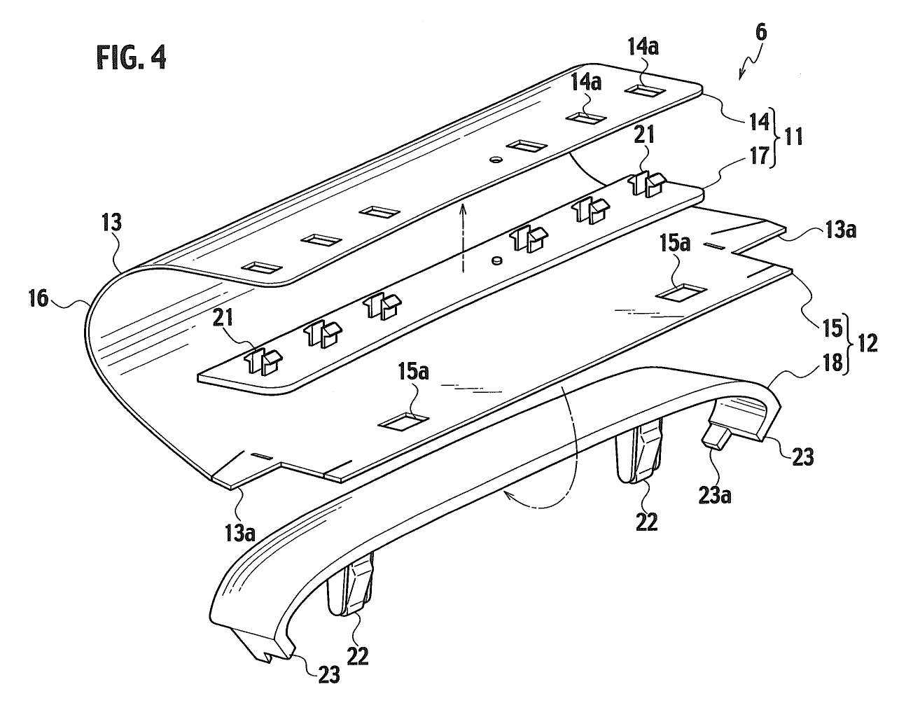

As shown in FIGS. 3 and 4, the cover 6 includes a flexible main element 13. The main element 13 has a sheet-shape and includes a pair of attached areas, which are an upper attached area 14 and a lower attached area 15, and an intermediate area 16 joining the two attached areas 14 and 15. The upper and lower attached areas 14 and 15 compose the upper and lower attachments 11 and 12, respectively. In other words, the upper attached area 14 composes the upper attachment 11 and the lower attached area 15 composes the lower attachment 12. Plural first through holes 14a are provided in line laterally (along a vehicle-width direction) at the upper attached area 14. The lower attached area 15 is folded back. Plural second through holes 15a are provided in line laterally at the lower attached area 15. The main element 13 is bent so as to have a U-shape side view.

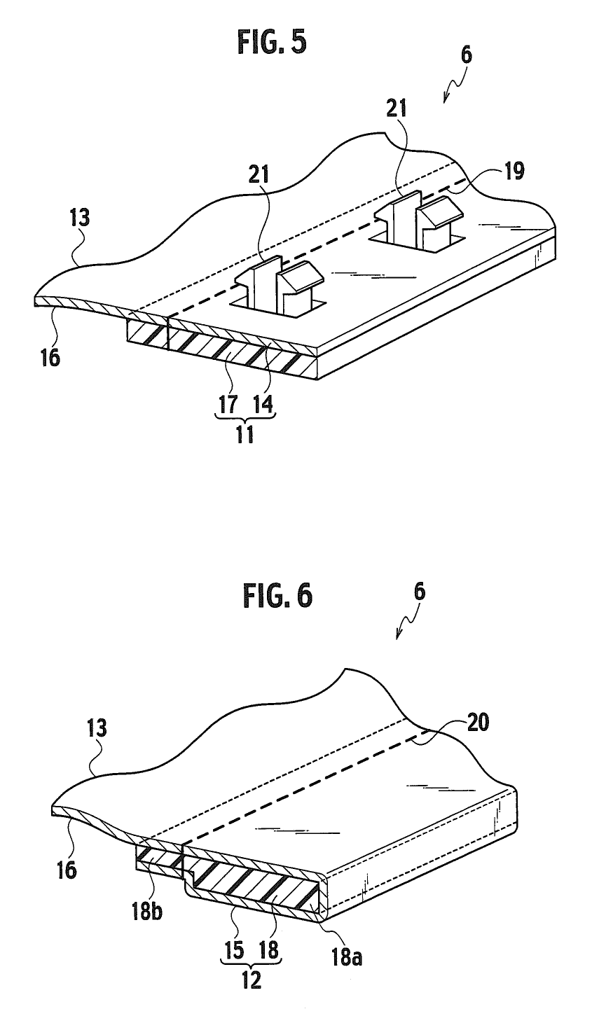

As shown in FIGS. 3, 5 and 6, upper and lower retainers 17 and 18 are fixed on the upper and lower attached areas 14 and 15 by sewing with strings 19 and 20, respectively. The upper and lower retainers 17 and 18 are made of resign and each has a plate-shape. The upper and lower retainers 17 and 18 have higher stiffness than the main element 13 to reinforce the upper and lower attached areas 14 and 15, respectively. The upper retainer 17 composes the upper attachment 11 and the lower retainer 18 composes the lower attachment 12.

As shown in FIGS. 3 and 4, the upper retainer 17 is made so as to be almost flat. The upper retainer 17 is fixed with the upper attached area 14 with being attached on a lower surface of the upper attached area 14 of the main element 13. Plural first hooks 21 are provide on an upper surface of the upper retainer 17 with being projected upward. Each of the first hooks 21 is composed of a pair of barbed tabs which stand back to back. The first hooks 21 are engaged with the instrument panel 2 with being inserted into the first through holes 14a and penetrating the instrument panel 2, respectively. The upper attachment 11 is fixed to the instrument panel 2 due to these engagements (see FIG. 1).

The lower retainer 18 is made so as to be almost flat at its intermediate area and curved downward at its both ends. The lower retainer 18 is fixed with the lower attached area 15 under a state where its upper and lower surfaces are covered by the lower attached area 15 of the main element 13. As shown in FIG. 6, the lower retainer 18 includes a thick part 18a and a thin part 18b. The thickness of the thin part 18b is thinner than that of the thick part 18a. The thin part 18b extends forward from a front edge of the thick part 18a. The lower attached areas 15 of the main element 13 is fixed with the thin part 18b of the lower retainer 18 by sewing.

As shown in FIGS. 3 and 4, plural clips 22 are provided in line laterally on a lower surface of the intermediate area of the lower retainer 18 with being projected diagonally downward. The clips 22 are engaged with the column cover 5 with being inserted into the second through holes 15a and penetrating an upper wall of the column cover 5, respectively (see FIG. 1). In addition, second hooks 23 are provided on both side ends of the lower retainer 18 with being projected downward, respectively. These two second hooks 23 are projected diagonally downward so as to exchanging bows each other. Each of the second hooks 23 includes a pawl 23a at its lower end. These pawls 23a are engaged with engaging holes (not shown) of the column cover 5, respectively. The lower attachment 12 is fixed to the column cover 5 due to these engagements of the clips 22 and the second hooks 23.

According to the above-described configurations, even if the column cover 5 is moved due to a tilt-adjustment or a telescopic adjustment of the position of the steering wheel 13, screening of the gap between the instrument panel 2 and the column cover 5 by the cover 6 can be kept by an elastic deformation of the cover 6 following the movement of the column cover 5.

As described above, in the present embodiment, the upper and lower attached areas 14 and 15 of the main element 13 are reinforced by the upper and lower retainers 17 and 18 at the upper and lower attachments 11 and 12 of the cover 6, respectively. Therefore, since shape-retainments of the upper and lower attachments 11 and 12 can be improved due to strengthening stiffness of the upper and lower attachments 11 and 12, attaching workability and an appearance of the cover 6 can be improved.

In addition, in the present embodiment, the upper and lower attached areas 14 and 15 are fixed to the upper and lower retainers 17 and 18 by sewing, respectively. Therefore, the upper and lower attached areas 14 and 15 can be firmly fixed with the upper and lower retainers 17 and 18, respectively.

In addition, the lower retainer 18 includes the thick part 18a and the thin part 18b and the lower attached area 15 is sewn onto the thin part 18b. Therefore, the shape-retainment of the lower attachment 12 is assured due to the thick part 18a and also the thin part 18b makes it easy to sew the lower attached area 15 onto the thin part 18b.

In addition, in the present embodiment, the upper attachment 11 has a conforming shape to the instrument panel 2 and the lower attachment 12 has a conforming shape to the column cover 5. Therefore, a good appearance can be obtained.

In addition, in the present embodiment, the width of the lower attachment 12 is made wider than that of the upper attachment 11. Since a frequently exposed area near the steering column 4 can be screened wider and also a hardly exposed portion of the cover near the instrument panel 2 can be down-sized, a good appearance and resource saving of the interior structure 7 can be obtained.

Note that the present invention is not limited to the above embodiment and can take other various embodiments within a range without deviancy from substance of the invention.

For example, in respect to the retainer, only one of the upper and lower retainers 17 and 18 may be provided.

In addition, the attached areas 14 and 15 may be fixed with the retainers 17 and 18 with adhesive, respectively.

What is claimed is:

1. An interior structure for a vehicle, comprising:
an instrument panel;
a column cover fixed to a steering column at a position surrounding the steering column; and
a cover which includes a pair of attachments and is positioned above the column cover for screening a gap between the instrument panel and the column cover, one of the attachments being attached to the instrument panel and another of the attachments being attached to the column cover;
wherein the cover further includes
a flexible main element including a pair of attached areas composing the attachments and a intermediate area joining the attached areas, and
a pair of retainers which are attached to the attached areas, respectively, and compose the attachments, respectively.

2. The interior structure according to claim 1, wherein
the attached areas are fixed to the retainers by sewing, respectively.

3. The interior structure according to claim 2, wherein
at least one of the retainers includes a thin area and a thick area, and
the attached area associated with the at least of the retainers is fixed to the thin area by sewing.

4. The interior structure according to claim 3, wherein
the thin area and the thick area extend in longitudinally parallel along the at least one of the retainers.

5. The interior structure according to claim 1, wherein
the one of the attachments has a conforming shape to the instrument panel, and
the other of the attachments has a conforming shape to the column cover.

6. The interior structure according to claim 1, wherein
a lateral width of the one of the attachments is made wider than a lateral width of the other attachments.
